(19) United States
(12) Patent Application Publication
(10) Pub. No.: US 2026/0253277 A1
(43) Pub. Date: Aug. 27, 2026

(54) INTERACTIVE IMAGE GENERATION USING ONE OR MORE TEXT, IMAGE, OR VISION NEURAL NETWORKS

(71) Applicant: Sony Interactive Entertainment LLC, San Mateo, CA (US)

(72) Inventors: Evan Jones, Raleigh, NC (US); Kyungseo Cho, Pittsburgh, PA (US); Khalil Bibi, Montreal (CA); Joseph Logan Olson, Glendale, CA (US)

(21) Appl. No.: 19/060,186

(22) Filed: Feb. 21, 2025

(51) Int. Cl. G06T 11/60; G06F 3/14; G06V 10/25; G06V 20/70

(52) U.S. Cl. CPC G06T 11/60; G06F 3/14; G06V 10/25; G06V 20/70; G06V 2201/07

(57) ABSTRACT

Methods, systems, and apparatus, including computer programs encoded on computer storage media, for generating an interactive image. One of the methods includes accessing an image; detecting a plurality of objects depicted in the image; generating, for at least some of the plurality of objects, one or more rules that define allowed interactions with the respective object; generating, using the image and the one or more rules for the at least some of the plurality of objects, an interactive image; and providing an instruction to cause the device to display the interactive image that depicts the plurality of objects.

### BACKGROUND

Neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of weights.

Neural networks can receive data for different types of input. The input can be text, images such as a video, or an audio signal, e.g., encoding speech or other sound. Neural networks can generate any appropriate type of output.

### SUMMARY

This specification relates to generating interactive images using neural networks.

In general, one aspect of the subject matter described in this specification can be embodied in methods that include the actions of accessing an image; detecting a plurality of objects depicted in the image; generating, for at least some of the plurality of objects, one or more rules that define allowed interactions with the respective object; generating, using the image and the one or more rules for the at least some of the plurality of objects, an interactive image; and providing an instruction to cause the device to display the interactive image that depicts the plurality of objects.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

In some implementations, the operations include receiving a seed input that includes one or more unrestricted phrases; and in response to receiving the seed input, generating an image prompt. In such implementations, accessing the image includes generating the image using the image prompt. In such implementations, generating the one or more rules includes generating the one or more rules that define a restricted set of allowed interactions with the respective object.

In some implementations, the operations include determining whether the one or more rules or the plurality of objects satisfy one or more validation criteria for the seed input; and selectively updating or determining to skip updating at least one of the image or the plurality of objects using a result of the determination whether the one or more rules or the plurality of objects satisfy the one or more validation criteria for the seed input.

In some implementations, selectively updating or determining to skip updating includes updating at least one of the image or the plurality of objects using a result of the determination whether the one or more rules or the plurality of objects satisfy the one or more validation criteria for the seed input. In such implementations, the updating can include adding, to a data object for an object depicted in the image, data indicating a second, different object is hidden inside the object until detection of an interaction with the object.

In some implementations, the operations include generating, using the image, two or more image segments. In such implementations, generating the one or more rules includes generating, using an image segment of the two or more image segments, a rule that defines a sequence of two or more allowed interactions each of which is for a respective object depicted in the image segment.

In some implementations, at least one pair of objects from the respective objects for allowed interactions from the sequence of two or more allowed interactions are a distance apart that satisfies a threshold distance.

In some implementations, detecting the plurality of objects depicted in the image uses a vision language model that receives, as input, data identifying candidate objects and the image and generates, as output and for each of the plurality of detected objects in the image, a label and location information. In such implementations, the location information can include a bounding box.

In some implementations, the operations include detecting a first plurality of objects depicted in a first image; determining whether there is an object in the first plurality of objects for each of the plurality of objects for which the one or more rules were generated; and generating a second image in response to determining that there is not an object in the first plurality of objects for each of the plurality of objects for which the one or more rules were generated. In such implementations, the image includes the second image; and detecting the plurality of objects includes detecting the plurality of objects in the second image.

In some implementations, the operations include detecting a first plurality of objects depicted in a first image; determining whether there is an object in the first plurality of objects for each of the plurality of objects for which the one or more rules were generated; and generating, as the image and using the first image, a second image by modifying the first image in response to determining that there is not an object in the first plurality of objects for each of the plurality of objects for which the one or more rules were generated. In such implementations, modifying the first image to generate the second image can include adding, to the first image, one or more objects from the plurality objects that were not included in the first plurality of objects detected in the first image.

In some implementations, the operations include detecting a first plurality of objects depicted in the image; and determining whether there is an object in the first plurality of objects for each of the plurality of objects for which the one or more rules were generated. In such implementations, detecting the plurality of objects depicted in the image is responsive to determining that there is not an object in the first plurality of objects for each of the plurality of objects for which the one or more rules were generated.

In some implementations, generating the one or more rules that define the allowed interactions with the respective object uses a large language model that receives, as input, a template that defines a rule layout and generates, as output, the one or more rules. In such implementations, the large language model can receive, as input, the template and data that identifies the plurality of objects.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various implementations and may result in one or more of the following advantages.

The technologies described in this specification can involve a system or a method that can enhance non-interactive images (e.g., images that do not allow for interaction by a user with the image) to generate interactive images with which a user can interact. For example, the user can be able to remove objects from the image, cause two or more objects in the image to interact with one another, and look around the space depicted in the image. The user can initiate such interactions by transmitting an input to a user device on which the image is displayed that indicates the desire of the user to initiate the interaction.

This can constitute an advantage over some existing technologies because the images generated in some existing technologies that use generative artificial intelligence (AI) to generate images in response to user input are static and do not allow for user interaction.

The technologies described in this specification can provide for checking whether components of the interactive image satisfy a set of validation criteria at various points throughout the process of generating the interactive image. This can increase a likelihood that the interactive image aligns with a one or more rules, e.g., that define a puzzle to be solved by a user, and the validation criteria can include whether the puzzle that would result from using the components to generate the interactive image has a solution.

This continuous checking for satisfaction of validation criteria and updating components accordingly can enhance the quality of the interactive image that is generated by the system. For example, it can increase the likelihood that the interactive image corresponds with a prompt received from a user, or that the generated interactive image corresponds to its context. It can improve the efficiency with which the system generates the interactive image. For example, if the system does not update any components of the interactive image until completion of the process of generating the interactive image, the system might waste computational resources, e.g., CPU cycles or memory or both, in restarting the entire process to generate a new interactive image in order to incorporate desired updates. By continuously checking and updating the interactive image throughout the generation process, the system can reduce a likelihood of generating interactive images that are not used and thus wasting resources.

In some implementations, the systems and methods described in this specification can use a segmented image to detect objects and generate rules to enhance a quality of a generated interactive image. For example, using a segmented image can increase a likelihood that objects that require an interaction with each other are separated by a distance that satisfies a distance threshold when those objects are depicted in the same segment of the interactive image. In some implementations, the systems and methods described in this specification can use overlapping images to increase a likelihood that objects that require an interaction with each other are separated by a distance that satisfies a distance threshold because objects that might otherwise be close by but in adjacent non-overlapping segments are more likely to be detected as satisfying the distance threshold.

In some implementations, the systems and methods described in this specification can use a previously generated image to generate an interactive image. This can improve the efficiency with which the system generates the interactive image. A previously generated image has a pre-selected setting and theme, and has objects placed within the image. Thus, by using a previously generated image to generate the interactive image, the system can reduce a likelihood of using more computational resources, e.g., can use fewer computational resources, in selecting a setting and theme, and in selecting and placing objects, to generate the interactive image compared to other systems.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example environment that includes a system configured to generate interactive images.

FIG. 2 is a flow diagram of an example process for generating an interactive image.

FIG. 3 shows an example of a computing device and associated accessories that can be employed to execute implementations of the present disclosure.

Like reference numbers and designations in the various drawings indicate like elements.

### DETAILED DESCRIPTION

Systems that use generative artificial intelligence (AI) can generate images and text in response to input from a user. However, once a generative AI system generates an image in response to user input, it can be difficult to enable continued interactions between the system and the user on the basis of the generated image, e.g., difficult to generate an interactive image or video sequence. For example, the generated image might be static, such that the system does not respond to attempts by the user to interact with the image. The system might only allow for user interaction with the generated image via text input.

A system can enhance a non-interactive image to create an interactive image with which the user can interact. The system can use a model to generate an image based on a text prompt from the user, use a previously generated image, or modify a previously generated image. The system can identify objects in the image using a vision model that generates bounding boxes for the identified objects.

The system can use a large language model to generate rules for the interactions with the identified objects. These rules can define a puzzle to be solved by the user or other appropriate types of interactions. In examples, the system can segment the image into multiple overlapping segments and generate the interactions using data representing individual segments, e.g., for a sequence of interactions with objects located in the same or adjacent segments. This segmentation of the image can result in a more realistic interactions.

In some implementations, the system can generate the rules for the interactions, e.g., in response to a prompt. The interactions can define objects for an interactive image. Using the generated rules, the system can generate the interactive image and the corresponding objects within the image.

The system can allow for multiple user devices to interact with an interactive image generated by the system. For example, the system can track a state of the generated image. The state of the generated image can change in response to interactions of some user devices with the image. If the state of the generated image changes in response to an interaction of a user device with the image, the system can track the change in state and adjust the presentation of the interactive image on the other user devices.

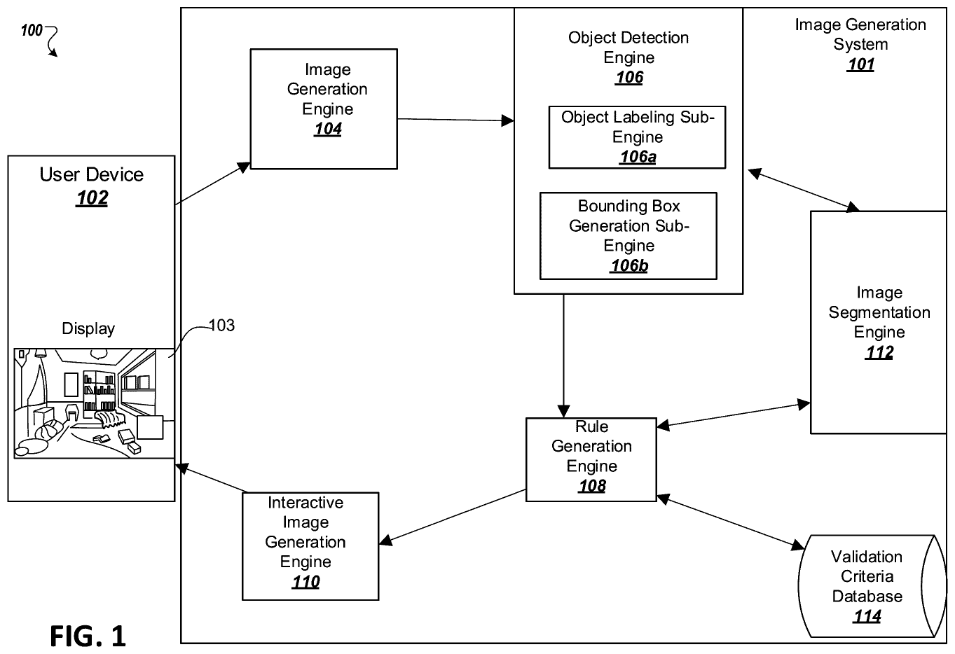

FIG. 1 is an example environment 100 that includes a system 101 configured to generate interactive images. The system 101 includes an image generation engine 104, an object detection engine 106, a rule generation engine 108, an interactive image generation engine 110, an image segmentation engine 112, and a validation criteria database 114. The system 101 can be in communication with a user device 102. The user device 102 can be a device with a display 103. The user device 102 can be configured to provide a user with a means of interacting with items displayed on the display 103, e.g., by touching a screen, clicking a mouse, moving a pointer, or providing audio input. For example, the user device 102 can be a phone, tablet, computer, or an XR device (e.g., an extended reality which includes virtual reality and augmented reality).

The image generation engine 104 can be configured to receive a prompt from the user device 102 and generate an image using the prompt. The prompt can be a text prompt. In some implementations, the image generation engine 104 can be configured to receive from the user device 102 a seed input including one or more phrases. In these implementations, the image generation engine 104 can provide the seed input to a prompt generation model that is configured to generate a text prompt using the seed input. In some implementations, the prompt generation model can be a large language model (LLM) that is configured to generate, e.g., expand, text prompts to be provided to text-to-image models.

The image generation engine 104 can be configured to provide input, e.g., the text prompt or other appropriate input, to an image generation model. The image generation model can be configured to generate an image using the text prompt. In some implementations, the image generation model can be a LLM. In some implementations, the image generation model can be a text-to-image model that is configured to receive text prompts from prompt generation model and generate images using the text prompts. In some implementations, the image generation engine 104 can be configured to provide the seed input directly to an image generation model. The image generation model can be a LLM configured to generate images using inputs such as the seed input.

The image generation model can have any suitable architecture. For example, the image generation model can be a diffusion model.

In some implementations, the image generation model can have been trained to generate images using text prompts or other inputs, such that it generates images for downstream use by the system 101 in generating an interactive image.

For example, the image generation model can have been trained to generate images with features such that the features are likely to result in the generation of an improved interactive image, e.g., one, that satisfies one or more puzzle criteria. An improved interactive image can be an interactive image that defines a puzzle to be interacted with by a user. For example, the image generation model can have been trained to enhance features including one or more of a number of objects in image, a density of objects throughout the image (e.g., how “cluttered” with objects the space depicted in the image appears to be), a camera angle from which the image is viewed, or any combination of these.

The image generation engine 104 can be configured to transmit the image generated by the image generation model to the object detection engine 106. The image generation engine 104 can use any appropriate type of communication protocol to transmit the image to the object detection engine 106.

The object detection engine 106 can include an object labeling sub-engine 106a and a bounding box generation sub-engine 106b. In some implementations, one or more of the object labeling sub-engine 106a or the bounding box generation sub-engine 106b are vision language models (VLM). In such implementations, the one or more of the object labeling sub-engine 106a or the bounding box generation sub-engine 106b can have any suitable architecture.

The object detection engine 106 can be configured to receive an image from the image generation engine 104 and, in response to receiving the image, detect a plurality of objects in the image. For example, the object detection engine 106 can generate a label and location information for each of a plurality of objects in the image.

The object detection engine 106 can detect a plurality of objects in the image using the object labeling sub-engine 106a, the bounding box generation sub-engine 106b, or both. For example, the object detection engine 106 can provide the received image to the object labeling sub-engine 106a. The object labeling sub-engine 106a can be, e.g., a VLM, configured to process the received image to generate a label for each of a plurality of objects in the image. In some implementations, the label for each of the plurality of objects can include one or both of the following parts: i) text representing a name for the object, or ii) text representing a description of the object. In some implementations, the object labeling sub-engine 106a can be configured to generate for the image a list of elements, where each element in the list corresponds to one of the plurality of objects and includes text representing a name for the object and text representing a description of the object.

The bounding box generation sub-engine 106b can be configured to receive as input the image to generate location data for each of the plurality of objects. In some instances, the bounding box generation sub-engine 106b can receive, as input, data related to the plurality of labels generated by the object labeling sub-engine 106a, e.g., region data for the objects associated with the labels. The location data can include a bounding box for the object. Region data can be data that indicates a portion of the image within which an object was detected that corresponds to the label, e.g., in contrast to the location data that is more specific to the corresponding object. A bounding box for an object can represent an area (e.g., a rectangular or box-shaped area) around the object in the image. The bounding box for an object can include at least two spatial coordinates associated with the object: a first spatial coordinate indicating the location of the top-left corner of the bounding box, and a second spatial coordinate indicating the location of the bottom-right corner of the bounding box. In some instances, the bounding box can indicate the center of the object and a height and a width.

In some implementations, the bounding box generation sub-engine 106b generates location data for each of the plurality of objects by first generating a bounding box for at least some, e.g., each, object and then reducing a size of the bounding box for the respective object. For example, for at least some objects, the bounding box generation sub-engine 106b can reduce the size of the bounding box for the object by removing from the bounding box regions that do not include the object. In this way, for at least some objects, the bounding box generation sub-engine 106b can cause the shape of the bounding box for the object to change from a rectangular or box-shaped area to a shape that more closely resembles the shape of the object, e.g., a polygon. For example, if the object is a circular tire, the shape of the bounding box can be changed from a rectangular shape surrounding the tire to a polygonal shape that resembles the circular shape of the tire. This can increase the accuracy with which the generated bounding boxes indicate locations of objects in the image, which can in turn enhance the quality of the interactive image that the system 101 generates.

In some implementations, the object detection engine 106 can first use the bounding box generation sub-engine 106b to generate location information for a plurality of objects in the received image. In such implementations, the location information for the plurality of objects can be provided to the object labeling sub-engine 106a to cause the object labeling sub-engine 106a to generate labels for the plurality of objects using the location information.

In some implementations, the system 101 can use the image segmentation engine 112, e.g., as part of the object detection process or another process. For example, the object detection engine 106 can provide the image it receives, or the image generation engine 104 can provide the generated image, to the image segmentation engine 112. The image segmentation engine 112 can be configured to divide the image into multiple overlapping segments to generate a segmented image. The number of overlapping segments included in the segmented image can be any suitable number. For example, the number of overlapping segments can depend on a size of the image, a density of objects depicted in the image, or both. The segments can be overlapping in order to increase the likelihood of accurately detecting adjacencies between objects in adjacent segments. For example, if the segments are disjoint and not overlapping, a first object on the right side of a first segment of the image might not be determined to be adjacent to a second object on the left side of a second segment of the image, where the second segment is adjacent to the first segment. By using segments that overlap, the image segmentation engine 112 can generate another segment that includes the first and second object on the right side of the other segment, and/or the first and second object on the left side of the other segment. This can enable the system to accurately detect the adjacency between the first object and the second object.

For example, as part of an adjacency detection process, the system can determine distances between objects that are located in the same segment. The system can determine that objects within the same segment, that are separated by a distance satisfies a distance threshold, or both, are adjacent to one another.

In some implementations, the image segmentation engine 112 can be configured to provide the segmented image back to the object detection engine 106. The object detection engine 106 can be configured to process each segment included in the segmented image separately to generate labels and location information for objects in the segment, as described above. The object detection engine 106 can then combine the labels and location information for the objects for all of the segments included in the segmented image. The combined labels and location information can define the plurality of objects that the object detection engine 106 detects in the image that it receives.

In some implementations, the object detection engine 106 can provide the image to the image segmentation engine 112 after processing the image using the object labeling sub-engine 106a. The image segmentation engine 112 can then process the image including labels for the objects in the image according to the process described above to generate a segmented image that includes labels for all of the objects in the image. The image segmentation engine 112 can provide the segmented image including labels for all of the objects in the image to the object detection engine 106 to be processed as described above. This can increase a likelihood that the system can determine that an object located in more than one segment represents the same object in each segment in which it is located.

In some instances, using a segmented image provided by the image segmentation engine 112 can help to increase the likelihood that the interactive image to be generated by the system 101 using the plurality of detected objects includes interactions between objects that are within a threshold distance of each other. This can in turn enhance the quality of the generated interactive image, user experience, or both. For example, if the interactive image defines a puzzle to be solved by a user, the quality of the puzzle can be enhanced by increasing the extent to which the object interactions to be initiated by the user to solve the puzzle involve interactions between objects that are within a threshold distance from each other, e.g., are close to each other. For example, if an interaction to be initiated to solve the puzzle is opening a drawer with a key, the user experience of initiating the interaction can be enhanced if the object representing the drawer is within a threshold distance from the object representing the key instead of being a distance greater than the threshold distance, e.g., on opposite sides of the image.

The rule generation engine 108 can be configured to receive data defining the plurality of objects detected by the object detection engine 106. The rule generation engine 108 can be configured to process the data to generate, for at least some of the plurality of objects, one or more rules that define allowed interactions with the respective object.

For example, for each of the plurality of objects for which the rule generation engine 108 generates rules, the rules can define which of the plurality of objects generated for the image by the object detection engine 106 can interact with the respective object. For each object allowed by the rules to interact with another object, such as a hammer breaking a stool, the rules can define a manner in which the object interacts with the other object. The manner in which the object interacts with the respective object can include one or more results of the interaction between the object and the respective object, e.g., a broken stool; one or more conditions under which the object can interact with the respective object, e.g., when the hammer can break the stool such when the stool is pulled out from under a desk; or any combination of these.

In some implementations, the interactions defined by the rules can include “undirected” interactions, or interactions that are independent of a direction. For example, in an undirected interaction, the interaction of a first object with a second object is identical to the interaction of the second object with the first object.

In some implementations, the interactions defined by the rules can include “directed” interactions, or interactions that are dependent upon a direction of the interaction. For example, in a directed interaction, the interaction of a first object with a second object is defined differently from the interaction of the second object with the first object. For instance, hitting a stool with a hammer has a different result than hitting a hammer with a stool.

In some implementations, the rule generation engine 108 can generate the rules for at least some of the plurality of objects using an LLM. In such implementations, the LLM can be configured to receive as input a template that defines a rule layout and generate as output the rules for at least some of the plurality of objects in the image. In such implementations, the LLM can have been trained to generate rules that allow interactions that can be incorporated into an interactive image to be generated by the system 101. For example, if the interactive image defines a puzzle to be solved by a user, the allowed interactions defined by the rules can be generated such that a potential difficulty of the puzzle presents a challenge for discovering how to initiate the interactions to solve the puzzle.

In some implementations, the rule generation engine 108 can generate the rules for at least some of the plurality of objects by communicating with the image segmentation engine 112. For example, the rule generation engine 108 can receive from the image segmentation engine 112 the segmented image. The rule generation engine 108 can use the segmented image to generate the rules for at least some of the plurality of objects. In some implementations, the rule generation engine 108 can generate the rules using one or more segments included in the segmented image. For example, the rule generation engine 108 can use the one or more segments to generate, for at least some of the segments, one or more rules that each define a sequence of two or more allowed interactions for objects depicted in the respective segment. For each of the one or more rules, the allowed interactions in the sequence can each involve an object in the same segment. In this way, the objects involved in the allowed interactions in the sequence can be a distance apart that satisfies a threshold distance, e.g., even though all of the objects in the sequence might not be in the same segment. For example, the objects involved in the allowed interactions in the sequence can be a distance apart that satisfies a threshold distance equal to the length of a dimension of the segment. In some implementations, the segmenting of the image can occur in response to transmission of the image to the image segmentation engine 112 by the rule generation engine 108.

Using the segmented image to generate the rules for at least some of the plurality of objects can increase a likelihood that the rules define interactions between objects that are local to one another. For example, the system can generate rules that allow for interactions between objects in the same image segment, and therefore that are a distance apart that satisfies a threshold distance. This can reduce computational resource usage for rule generation by the system 101 using the rules because the rule generation engine 108 can consider a subset of all possible object pairs, e.g., the subset of object pairs that include objects that are a distance apart that satisfies a threshold distance, for rule generation and corresponding interactions, instead of considering all object pairs, e.g., including those that do not have a distance apart that satisfies the threshold distance.

In some implementations, the rule generation engine 108 can use a distance threshold when generating the rules. The distance threshold can cause the rules generated by the rule generation engine 108 to only allow interactions between two objects that are a distance apart that satisfies the distance threshold, e.g., is less than, equal to, or either, the distance threshold. For example, without the distance threshold, the rule generation engine might generate a rule that requires a user to have one object from one side of the image interact with an object on the other, such as using a key from the left side to unlock a lock on the right side. For example, without the distance threshold, the rule generation engine might generate a rule that requires a user to interact with an object from one side of the image and use a result of the interaction to interact with an object on the other side of the image, such as repairing a ladder from the left side to use to reach a high shelf on the right side.

By using the distance threshold, the system can increase a likelihood that none of the rules require such an interaction. The system would use the distance threshold, that is based on the image segmentation process, to determine to generate a rule for objects that are depicted in the same image segment, e.g., only for objects depicted in the same image segment.

In some implementations, the rule generation engine 108 communicates with the validation criteria database 114. The validation criteria database 114 can maintain a set of validation criteria for the seed input. The validation criteria can be criteria to be satisfied by an output of the system 101 in generating the interactive image. For example, the validation criteria can be criteria to be satisfied by the plurality of objects detected by the object detection engine 106, the rules generated by the rule generation engine 108, or both. For example, the validation criteria can include, for a given output of the system 101, whether the output sufficiently corresponds to the prompt generated using the seed input, or to the image generated using the seed input, or both. In some examples, the validation criteria can include, for a given output of the system 101, whether the output is likely to result in the generation of an interactive image that can be used for a puzzle. For example, if the interactive image defines a puzzle to be solved by a user, the validation criteria can include criteria for whether the puzzle that would result from using the output to generate the interactive image is likely to be sufficiently interesting, challenging, or difficult for the user.

The rule generation engine 108 can communicate with the validation criteria database 114 to determine whether the generated rules, the plurality of detected objects, or both, satisfy at least some, e.g., each, validation criterion in the set of validation criteria. If the rule generation engine 108 determines that at least one of the validation criteria is not satisfied, the rule generation engine 108 can cause the system 101 to update either the image generated by the image generation engine 104, the plurality of objects detected by the object detection engine 106, or both.

The update performed by the system 101 in response to such a determination by the rule generation engine 108 can use a result of the determination. In some implementations, the update can include generating a new image. In some implementations, the update can include adding one or more objects to the image. In some implementations, the update can include adding data to a data object for an object in the image, where the added data indicates that a second, different object is hidden inside the object until detection of an interaction with the object. For example, such an update can enhance the quality of the interactive image to be defined by interactions between the objects, e.g., by making a puzzle or another type of game defined by the interactive image more interesting or challenging for a user.

The rule generation engine 108 can repeat the process described above for determining whether the generated rules, the plurality of detected objects, or both, satisfy each validation criterion in the set of validation criteria. For example, the rule generation engine 108 can repeat the process until the generated rules, the plurality of detected objects, or both, satisfy the validation criteria in the set of validation criteria. Once the validation criteria in the set of validation criteria are satisfied, the rule generation engine 108 can determine to skip causing the system 101 to update either the image generated by the image generation engine 104, the plurality of objects detected by the object detection engine 106, or both. For instance, the system 101 can use the image in additional processing, provide instructions for presentation of the image, or both.

In some implementations, when the rule generation engine 108 determines that at least one of the validation criteria is not satisfied, the determination or the resulting update, or both, can be communicated to one or more of the image generation engine 104 or the object detection engine 106. For example, the determination or the resulting update, or both, can be used by the system to train one or more of: the LLM included in the image generation engine 104 or the one or more VLMs included in the object detection engine 106. For example, parameters of the respective model can be updated using the determination or the resulting update, or both.

The rule generation engine 108 can be configured to transmit the generated image, the plurality of detected objects, and the generated rules to the interactive image generation engine 110. The interactive image generation engine 110 can be configured to process the generated image, the plurality of detected objects, and the generated rules to generate an interactive image.

The generated interactive image can be an image that includes selectable user interface elements with which a user is able to interact. The user can be able to interact with the interactive image by initiating an interaction with one or more objects, as selectable user interface elements, in the interactive image, where the interaction is an interaction allowed by the generated rules. The interaction can involve a single object in the interactive image, or can involve more than one object in the interactive image, e.g., the interaction can be an interaction between objects in the interactive image. For example, the user can be able to remove objects from the image, cause two or more objects in the image to interact with one another, and look around the space depicted in the image. In some implementations, a user device on which the image is displayed can receive input, e.g., from the user, that indicates the desire of the user to initiate the interaction.

In some implementations, the system 101 can keep track of interactions by the user with the interactive image and update the interactive image in real time to reflect the interactions. For example, if the interaction involves receipt of input indicating removal of an object from the image, the system 101 can update the interactive image so that the updated interactive image no longer includes the removed object. If the interaction involves two or more objects interacting with one another, or input indicating a changed state of an object, the system 101 can update the interactive image so that the updated interactive image includes a depiction of a result of the interaction of the two or more objects, e.g., a broken stool or opened door.

The interactive image can represent any appropriate type of game. In some implementations, the interactive image can define a puzzle for a user of the system 101 to solve. In some implementations, the interactive image can define a hidden object game for a user of the system 101 to play. In such implementations, the system 101 can keep track of interactions by the user with the interactive image and update the interactive image accordingly, as described above. Each interaction by the user with the image can update the progress of the user with respect to solving the puzzle or playing the game defined by the image. The system 101 can keep track of the progress of the user and update the progress of the user according to the interactions of the user. For example, the system can update the interactive image to reflect the progress of the user.

In some implementations, one or more of the interactions allowed by the generated rules can result in a change of state of one or more of the objects involved in the interaction. For each of the one or more objects, the interactive image generation engine 110 can represent the change in state of the object by replacing the depiction of the changed object with a depiction of a new object in the interactive image, e.g., which new object represents the changed state.

In some implementations, for each of the one or more interactions that result in a change of state of one or more objects, the interactive image generation engine 110 can increase a likelihood that the change in state of the one or more objects is accurately reflected by the new one or more objects with which they are replaced. The interactive image generation engine 110 can use an LLM for this process, e.g., the same LLM that generates the prompt for input to the text-to-image model. For example, for each interaction and for each object of which the interaction results in a change of state, the interactive image generation engine 110 can first remove the object from the interactive image. The interactive image generation engine 110 can next generate three candidate objects, where each candidate object is a potential new object to replace the removed object. In some implementations, the three candidate objects can be generated using an LLM. For example, the LLM can be configured to use data for the removed object, e.g., one or more portions of the label, data that indicates the action performed on the object, or both, to generate a text prompt to be provided to a text-to-image model. The text-to-image model can be configured to generate the candidate objects using the text prompt.

The interactive image generation engine 110 can next select one of the three candidate objects to replace the removed object. The interactive image generation engine 110 can select the candidate object to replace the removed object using one or more criteria. The one or more criteria can include any suitable criteria. For example, the one or more criteria can include which of the three objects would result in a high-quality interactive image if used to replace the removed object in the interactive image. In implementations in which the interactive image defines a puzzle to be solved or another type of game to be played by a user, a highly-quality interactive image can be an interactive image that defines the puzzle or other game that is predicted to be challenging or interesting for the user, that is predicted to most accurately represent a real space, or both. For instance, the system 101 can select an image that likely has fewer artifacts as a result of the image generation process that might not be realistic. In some examples, the one or more criteria can include which of the three objects would result in the use of the fewest computational resources by the system 101 if included in the interactive image. The use of such criteria can help to increase the efficiency of the operation of the system 101.

In implementations in which the interactions defined by the rules include directed interactions, a directed interaction defined by the rules can result in a change of state of one or more objects in one or more of the directions of the interaction. For each direction of the interaction that results in a change of state of one or more objects, the interactive image generation engine 110 can increase a likelihood that the change in state of the one or more objects is accurately reflected by the new one or more objects with which they are replaced in the same manner described above. The system 101 can provide an instruction to cause the interactive image generated by the interactive image generation engine 110 to be displayed on a display 103 of the user device 102. A user of the user device 102 can interact with the interactive image by using a means of interaction provided by the user device 102, as described above.

In some implementations, the system 101 can be configured such that the rule generation engine 108 receives the prompt from the user device 102. The prompt can indicate a set of interaction between objects to be included in an interactive image. For example, in implementations in which the interactive image defines a puzzle or another type of game, the prompt can indicate desired features of the puzzle or other type of game. In such implementations, the rule generation engine 108 can be configured to process the prompt to generate one or more rules that define allowed interaction between objects. For example, the interactions between objects allowed by the generated rules can enable the features of the puzzle or other type of game indicated in the prompt.

The rule generation engine 108 can provide the generated rules to one or more of the image generation engine 104 or the object detection engine 106. The image generation engine 104 can be configured to generate an image, in a manner similar to that described above, using the generated rules, such that the generated image corresponds with the generated rules. For example, the generated image can be an image of a space the enables the interactions defined by the generated rules.

In such implementations, the object detection engine 106 can be configured to detect a plurality of objects, in the manner described above, using the generated rules, such that the plurality of objects corresponds with the generated rules. For example, the plurality of objects can include objects between the generated rules define interactions. The object detection engine 106 can detect the plurality of objects before or after the image generation engine 104 generates an image using the generated rules. If the object detection engine 106 detects the plurality of objects before the image generation engine 104 generates an image using the generated rules, the object detection engine 106 can transmit the detected plurality of objects to the image generation engine 104 to be used in generating the image. If the object detection engine 106 detects the plurality of objects after the image generation engine 104 generates an image using the generated rules, the object detection engine 106 can use the generated image, along with the generated rules, to detect the plurality of objects.

In such implementations, the interactive image generation engine 110 can be configured to use the generated image, the plurality of objects, and the generated rules to generate an interactive image, as described above.

In some other implementations, the system 101 can be configured such that the object detection engine 106 receives the prompt from the user device 102. In such implementations, the prompt can indicate a plurality of objects to be included in an interactive image. The object detection engine 106 can be configured to process the prompt to generate a plurality of objects corresponding to the prompt. The object detection engine 106 can provide the plurality of objects to one or more the image generation engine 104 and the rule generation engine 108. The image generation engine 104 can be configured to generate an image, in a manner similar to that described above, using the plurality of objects, such that the generated image corresponds with the plurality of objects. For example, the generated image can include the plurality of objects.

In such implementations, the rule generation engine 108 can be configured to generate rules defining allowed interactions between objects included in the plurality of objects generated by the object detection engine 106, in a manner similar to that described above. The rule generation engine 108 can generate the rules before or after the image generation engine 104 generates an image using the plurality of objects. If the rule generation engine 108 generates the rules before the image generation engine 104 generates an image using the plurality of objects, the rule generation engine 108 can transmit the generated rules to the image generation engine 104 to be used in generating the image. For example, the image generation engine 104 can generate an image that includes the plurality of objects, and in which the objects included in the plurality of objects are located in such a way that enables the interactions between the objects defined by the generated rules. If the rule generation engine 108 generates the rules after the image generation engine 104 generates an image based on the generated rules, the rule generation engine 108 can use the generated image, along with the plurality of objects, to generate the rules, in the manner described above.

In such implementations, the interactive image generation engine 110 can be configured to use the generated image, the plurality of objects, and the generated rules to generate an interactive image, as described above.

In some implementations, the system 101 can generate a 3D model of a virtual space, a floor plan, or a panorama of multiple images, or any combination of these. For example, after the system 101 generates the image using the image generation engine 104, the system 101 can use the generated image to generate the 3D model of a virtual space, floor plan, panorama, or combination thereof. In such implementations, the 3D model of a virtual space, floor plan, panorama, or combination thereof can be used by the system to generate an interactive image that corresponds to a prompt, for example, in the manner described above.

In some implementations, the system can generate interactions that define a puzzle or another type of game corresponding to the real-world environment of the user. For example, the system can be implemented into a camera or smart glasses. In such implementations, the object detection engine 106 can be configured to detect a plurality of objects in an environment of the user. In such implementations, the rule generation engine 108 can be configured to generate rules defining interactions between the objects detected in the environment of the user. The interactive image generation engine 110 can be configured to generate an interactive image, for example, in the manner described above, such that the interactive image corresponds to the environment of the user.

For example, the interactive image can be a puzzle that the user can solve by moving around in their environment and interacting with objects in the environment. The system 101 can be configured to detect the interactions of the user with the environment. The system 101 can update the progress of the user with respect to solving the puzzle in response to the interactions. The system 101 can keep track of the interactions of the user with the environment and, optionally, of the progress of the user with respect to solving the puzzle that results from the interactions. The system 101 can update the interactive image in response to the interactions of the user with the environment so as to reflect an updated progress of the user with respect to solving the puzzle.

In implementations in which the interactive image defines a puzzle for a user to solve, features from the puzzle can carry over to additional related puzzles or other types of games generated by the system. For example, while the user is solving the puzzle, a first space depicted in the interactive image can include a door to a second space depicted to be adjacent to the first space. Using operations substantially similar to those described above, the system can generate a second interactive image that depicts the second space and defines a second puzzle corresponding to the second space. The system can generate the second interactive image such that themes, objects, or both, from the puzzle defined by the original interactive image are present in the second puzzle. In some implementations, the system can repeatedly generate additional interactive images in this way, each additional interactive image defining a corresponding additional puzzle. For example, the system can repeatedly generate additional interactive images such that themes, objects, or both, from the puzzle defined by the original interactive image are present in one or more of the additional puzzles. This can enhance the experience of the user interacting with the interactive image by providing for continuity across one or more interactive images with which the user interacts.

In some implementations, the interaction of the user with the interactive image can be limited to be within a defined “round”. A round can be defined by a period of time after which the user is prevented from further interaction with the interactive image. The round can be defined by an indication of the progress made by the user in solving a puzzle or playing another type of game (e.g., completion of the puzzle or other type of game) defined by the interactive image. For example, once the period of time that defines the round expires, the system can prevent the user from further interacting with the interactive image. In some examples, upon detection by the system of the indication of the progress by the user that defines the round, the system can prevent the user from further interacting with the interactive image.

In such implementations, upon completion of a first round, the system can provide an additional interactive image with which the user can interact. The system can have generated the additional interactive image in the manner described above. The system can limit the interaction of the user with the additional interactive image to be within a second round, the second round being defined similarly to the first round. This process can be repeated for multiple rounds of interaction by the user with multiple additional interactive images.

In such implementations, the system can generate additional interactive images such that objects from the original interactive image that the user did not interact with in a previous round are included in one or more of the additional interactive images. This can improve the efficiency with which the system generates additional interactive images because the system can recycle objects that it detected while generating an interactive image for a previous round, allowing it to detect a smaller plurality of objects in an additional interactive image while still providing for a sufficient quantity of objects to be included in the additional interactive image.

In some implementations, the system can generate additional interactive images that depict an expanded view of an object in the original interactive image. For example, in response to a user interaction with an object in the original interactive image, the system can generate an additional interactive image that depicts a view of the object such that it appears to the user as if the user has “zoomed in” on the object. For example, the additional interactive image can depict the object with increased detail than in the original interactive image. The additional interactive image can depict additional features of the object that were not depicted in the original interactive image. The additional interactive image can depict one or more features of the object at a larger scale than they were depicted in the original interactive image.

In some implementations, the system can record data indicative of interactions by a user with the interactive image. The data can be used by the system to train one or models included in the system. For example, using the data, the parameters of one or models included in the system can be updated so as to optimize the operations performed by the one or more models. The operations performed by the one or more models can be optimized so as to optimize the process by which the system generates interactive images.

In some implementations, the system can generate an interactive image with which multiple users across multiple user devices are able to interact. In such implementations, the system can keep track of the interactions of each user with the interactive image. In response to an interaction by any of the multiple users, the system can update the interactive image displayed on each of the multiple user devices to reflect the interaction. This allows for the participation of multiple users in a puzzle or another type of game defined by the interactive image, which can enhance the experience of interacting with the interactive image for the user.

In some implementations, the image generation engine 104 can receive an image from the user device 102, e.g., that is uploaded by a user to the user device 102. In such implementations, the image generation engine 104 can be configured to transmit the received image directly to the object detection engine 106. In some other implementations, the image generation engine 104 can process the received image using a model to modify the received image. For example, the image generation engine 104 can modify the received image to optimize the received image for downstream use by the system 101. The image generation engine 104 can modify the received image to optimize the interactive image to be generated by the system 101 using the received image, e.g., by optimizing the quality of a puzzle or another type of game to be defined by the generated interactive image. In such implementations, the image generation engine 104 can be configured to transmit the modified image to the object detection engine 106.

The system 101 is an example of a system implemented as computer programs on one or more computers in one or more locations, in which the systems, components, and techniques described in this specification are implemented. The user device 102 can include personal computers, mobile communication devices, and other devices that can send and receive data over a network. The network (not shown), such as a local area network (“LAN”), wide area network (“WAN”), the Internet, or a combination thereof, connects the user device 102 and the system 100. The system 101 can use a single computer or multiple computers operating in conjunction with one another, including, for example, a set of remote computers deployed as a cloud computing service.

The system 101, e.g., an interactive image generation system, can include several different functional components, including the image generation system 104, the object detection engine 106, the image segmentation engine 112, the rule generation engine 108, the interactive image generation engine 110, and the sub-engines 106a-b. Any one or more of the components can include one or more data processing apparatuses, can be implemented in code, or a combination of both. For instance, each of the components can include one or more data processors and instructions that cause the one or more data processors to perform the operations discussed in this specification.

The various functional components of the system 101 can be installed on one or more computers as separate functional components or as different modules of a same functional component. For example, the components of the system 101 described above can be implemented as computer programs installed on one or more computers in one or more locations that are coupled to each through a network. In cloud-based systems for example, these components can be implemented by individual computing nodes of a distributed computing system.

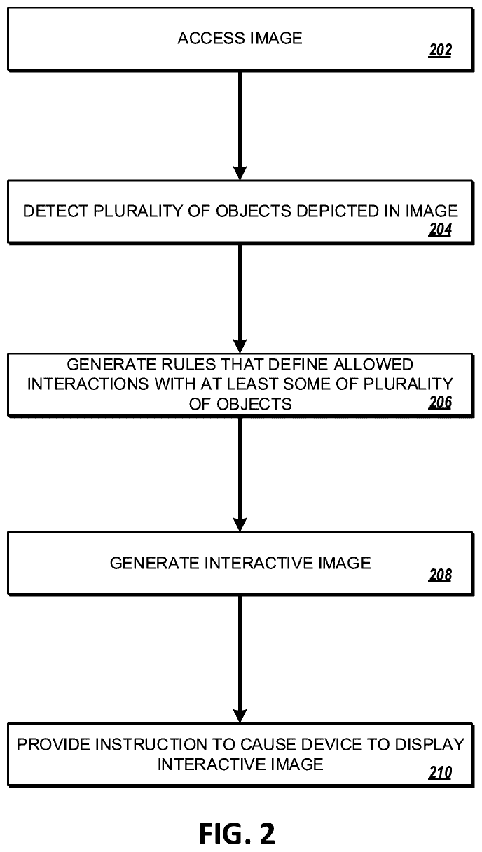

FIG. 2 is a flow diagram of an example process 200 for generating an interactive image. For example, the process 200 can be used by the system 101 of FIG. 1 for generating an interactive image.

The system accesses an image (202). The system can receive an image from a user (e.g., uploaded to the system from a user device). The system can use the received image in the state in which it is received. In some examples, the system can modify the received image using a model. For example, the system can modify the received image using operations substantially similar to those described with reference to FIG. 1.

In some implementations, the system can access the image by first receiving a seed input of one or more unrestricted phrases from a user. The seed input can be provided to a model that generates an image prompt for generating an image using the seed input. The image prompt can then be passed to a model (e.g., an LLM) that generates an image using the prompt, the seed input, or both. The model can be substantially similar to the image generation model described with reference to FIG. 1. For example, the system can process the seed input to generate an image using operations substantially similar to those described with reference to FIG. 1.

The system detects a plurality of objects depicted in the image (204). The system can detect the plurality of objects using a vision language model (VLM) included in the system. For example, the VLM can be configured to receive as input data identifying candidate objects in an image. The VLM can be configured to, in response to receiving the input data, generate a label and location information for the identified candidate objects. In some implementations, the location information can include bounding boxes for the identified candidate objects.

In some implementations, the system can use multiple VLMs in detecting the plurality of objects depicted in the image. For example, a first VLM can be configured to, upon receiving data identifying candidate objects in an image, generate labels for the identified candidate objects in the image. A second VLM can be configured to receive those labels and generate the bounding boxes for the labeled objects. In some implementations, the data identifying candidate objects can first be received by the second VLM, which can then transmit bounding boxes generated by the second VLM to the first VLM to generate labels for the candidate objects using the bounding boxes. For example, the first and second VLMs can be substantially similar to the object labeling sub-engine 106a and the bounding box generation sub-engine 106b of FIG. 1, respectively.

In some implementations, the system can detect the plurality of objects depicted in the image by segmenting the image into multiple overlapping segments. For example, the system can use a segmented image generated by segmenting the image into multiple overlapping segments via operations substantially similar to those described with reference to FIG. 1.

The system generates, for at least some of the plurality of objects, one or more rules that define allowed interactions with the respective object (206). The rules can be generated by a large language model (LLM) that is included in the system. The LLM can be configured to receive as input a template that defines a rule layout and generate as output the one or more rules that define interaction with each object of at least some of the plurality of objects in the image.

The LLM can be trained to generate rules that allow interactions that optimize a puzzle to be defined by the interactions. For example, the LLM can be trained in a manner substantially similar to that of the training of the LLM included in the rule generation engine 108 of FIG. 1.

In some implementations, the system can generate the rules by segmenting the image into multiple overlapping segments. In some implementations, the system can use the segmented image generated during the detection of the plurality of objects described above. For example, the system can use a segmented image generated by segmenting the image into multiple overlapping segments via operations substantially similar to those described with reference to FIG. 1.

In some implementations, after generating the rules, the system can check if the generated rules or the plurality of detected objects, or both, satisfy validation criteria for the seed input. For example, the system can communicate with a validation criteria database that maintains validation criteria for the seed input in order to check for satisfaction of the validation criteria by the generated rules or the plurality of detected objects, or both. In some implementations, the system can check if the generated rules or the plurality of detected objects, or both, satisfy validation criteria using operations substantially similar to those described with reference to FIG. 1.

In such implementations, if the system determines one or more of the validation criteria are not satisfied, the system can selectively update at least one of the image or the plurality of objects using a result of the determination. For example, the system can selectively update at least one of the image or the plurality of objects such that the updated image or plurality of objects is more likely to satisfy the validation criteria. In some implementations, the system can selectively update at least one of the image or the plurality of objects by adding, to a data object for an object depicted in the image, data indicating a second, different object is hidden inside the object until detection of an interaction with the object. If the system determines that all validation criteria are satisfied, the system can determine to skip updating the image or the plurality of objects.

The system generates an interactive image (208). The system can generate the interactive image using the image accessed by the system and the one or more rules for at least some of the plurality of objects generated by the system.

The interactive image can be an image with which a user is able to interact using one or more types of interactions. For example, a user can interact with the interactive image by, e.g., removing objects from the image, causing objects in the image to interact with one another, or looking around the space depicted in the image, or any combination of these.

In some implementations, the interactive image can define a puzzle, a hidden object game, or another type of game for a user of the system to play. The interactions of the user with the interactive image can represent actions taken by the user in solving the puzzle or playing the other type of game. The interactions of the user with the interactive image can result in updates to the progress of the user with respect to solving the puzzle or playing the other type of game.

In some implementations, a user can interact with the interactive image by causing a change of state of one or more of the objects involved in the interaction. In such implementations, the system can increase the likelihood that the change of state is accurately reflected in the interactive image using operations substantially similar to those described above with reference to FIG. 1.

The system provides an instruction to cause a device to display the interactive image that depicts the plurality of objects (210). For example, the system can provide an instruction to cause the interactive image to be displayed on a user device (e.g., phone, tablet, computer, XR device (extended reality which includes virtual reality and augmented reality)). In some implementations, once the interactive image is displayed on the user device, a user of the user device can interact with the interactive image using a type of interaction provided by the user device. For example, the user can interact with the interactive image by one or more of clicking a button, touching a screen, or providing audio input.

The order of operations in the process 200 described above is illustrative only, and generating an interactive image can be performed in different orders. For example, the system can first generate rules that define allowed interactions with at least some of a plurality of objects, e.g., in response to receiving a prompt from a user that indicates a set of interaction between objects to be included in an interactive image. The system can use the generated rules to generate an image and detect a plurality of objects in the image. In some examples, the system can use the generated rules to generate a plurality of objects and finally generate an image using the plurality of objects and the generated rules.

In some examples, the system can first generate a plurality of objects, e.g., in response to receiving a prompt from a user that indicates a plurality of objects to be included in an interactive image. The system can use the generated plurality of objects to generate a corresponding image and then generate one or rules using the plurality of objects and the image; or to generate one or more rules and then generate an image using the plurality of objects and the one or more rules.

In some implementations, the process 200 can include additional operations, fewer operations, or some of the operations can be divided into multiple operations. For example, the process 200 can include one or more of the additional operations performed by the system 101 described with reference to FIG. 1. In some instances, the process 200 might not include image generation, e.g., when the process 200 receives a previously captured or otherwise generated image.

In this specification, the term “database” can broadly to refer to any collection of data: the data does not need to be structured in any particular way, or structured at all, and it can be stored on storage devices in one or more locations. A database can be implemented on any appropriate type of memory.

In this specification the term “engine” can broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

Operations can occur substantially concurrently in that the operations need not be exactly concurrent but can overlap at least in part. For instance, a first operation can begin and sometime after that a second operation can begin while the first operation is still occurring. Execution of the two operations, whether by the same system or different systems, can be substantially concurrently. In some examples, two operations can execute substantially concurrently when they have the same start time, same end time, or both.

In this specification, the term likely can mean that there is a likelihood that something might occur and that the likelihood satisfies a likelihood threshold. For instance, when determining a likely label, e.g., name, for an object in an image, a system would determine a likelihood that the label correctly identifies the object. The system would then determine whether the likelihood satisfies, e.g., is greater than or equal to, a likelihood threshold by comparing the two values. If so, the system determines that the label likely applies to the object. If not, the system determines that the object should not have the label, e.g., and can determine a different label for the object.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks.

However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

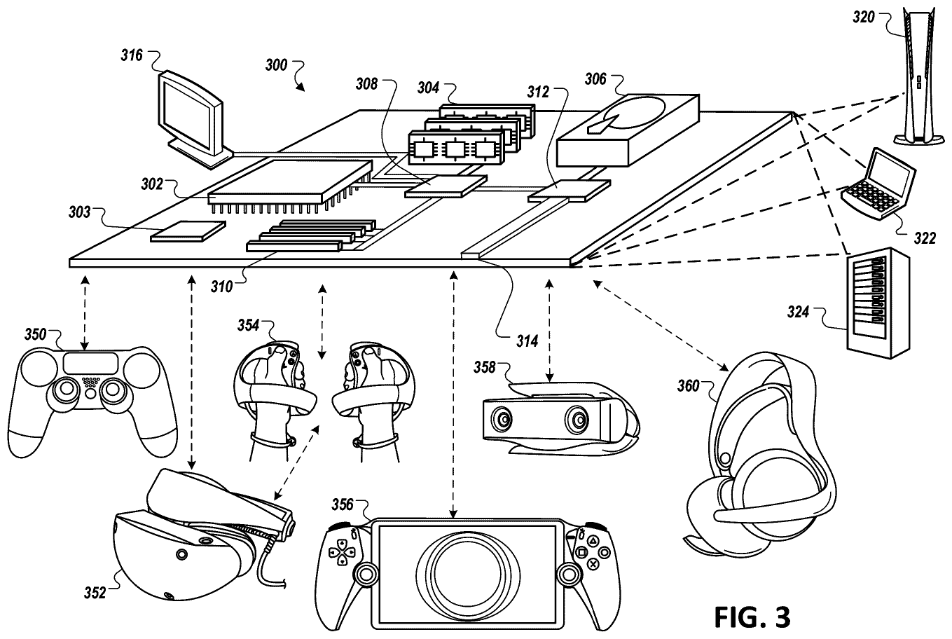

FIG. 3 shows an example of a computing device 300 and associated accessories that can be employed to execute implementations of the present disclosure. The computing device 300 can be a gaming console 320, such as PS5®, PS4®, PS3®, PS2® etc., or as one or more servers 324 or as a rack within a server. In some implementations, the computing device 300 may be implemented as a personal computer such as a laptop computer 322. In some implementations, the computing device 300 can be implemented as a mobile device such as the connected handheld gaming device 356. In some implementations, a computing device can include one or more of the computing device 300, and an entire system may be made up of multiple computing devices communicating with each other. For example, a gaming system can include one or more of a gaming console 320, one or more accessories, and a remote platform such as a cloud-based platform implemented on one or more servers 324. The computing device can also include a desktop computer, a workstation, a personal digital assistant, a server, a blade server, a mainframe, or other appropriate type of computer. The components shown here, their connections and relationships, and their functions, are examples only, and are not limiting.

In various implementations, the computing device 300 includes some combination of one or more processors or central processing units (CPUs) 302, one or more graphic processing units (GPUs) 303, memory 304, one or more storage devices 306, a high-speed interface 308, and/or a low-speed interface 312. In some implementations, the high-speed interface 308 connects to the memory 304 and multiple high-speed expansion ports 310. In certain implementations, the low-speed interface 312 connects to a low-speed expansion port 314 and the storage device 304. In some implementations, the high-speed interface 308 connects to the storage device 304. Each of the processor 302, the GPU 303, the memory 304, the storage device 306, the high-speed interface 308, the high-speed expansion ports 310, and the low-speed interface 312, are interconnected using various buses, and may be mounted on a common motherboard or in other manners as appropriate.

The processor 302 can process instructions for execution within the computing device 300, including instructions stored in the memory 304 and/or on the storage device 306 to display graphical information for a graphical user interface (GUI) on an external input/output device, such as a display 316 coupled to the high-speed interface 308. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 304 stores information within the computing device 300. In some implementations, the memory 304 includes a volatile memory unit or units. Alternatively, or in addition, the memory 304 can include a non-volatile memory unit or units. The memory 304 may also include another form of a computer-readable medium, such as a magnetic or optical disk. In some implementations, the memory 304 includes Graphics Double Data Rate (GDDR) memory such as GDDR6 memory configured to provide a unified memory architecture with a high bandwidth. In some implementations, the memory can include high speed memory such as GDDR2, GDDR3, GDDR4, GDDR5, GDDR5X, GDDR6X, GDDR6W or GDDR7. Such high-speed memory can facilitate rapid data access and seamless multitasking, supporting gaming and multimedia applications.

The storage device 306 provides mass storage for the computing device 300. In some implementations, the storage device 306 may be or include a computer-readable medium, such as a hard disk device, an optical disk device, a flash memory, or other similar solid-state memory device, or an array of devices, including devices in a storage area network or other configurations. In some implementations, the storage device 306 can include a high capacity solid-state drive (SSD) configured to support a high throughput (e.g., 5.5 GB/s or more). Such an SSD can facilitate fast load times, enabling near-instantaneous game booting, level transitions, and asset streaming. In some implementations, the storage device 306 can be configured to support expandable storage via compatible non-volatile memory express (NVMe) SSDs. Instructions can be stored in an information carrier, and when executed by one or more processing devices, such as processor 302, perform one or more methods, such as those described above. The instructions can also be stored by one or more storage devices, such as non-transitory computer-readable or machine-readable mediums, such as the memory 304, the storage device 306, or memory on the processor 302. The instructions can constitute software for providing interactive game play on a user interface such as a graphical user interface (GUI) presented on the display 316.

The high-speed interface 308 generally manages bandwidth-intensive operations for the computing device 300, while the low-speed interface 312 generally manages lower bandwidth-intensive operations. Such allocation of functions is an example only. In some implementations, the high-speed interface 308 is coupled to the memory 304, the display 316 (e.g., through a graphics processor or accelerator), and to the high-speed expansion ports 310, which accepts various expansion cards. In the implementation, the low-speed interface 312 is coupled to the storage device 306 and the low-speed expansion port 314. The low-speed expansion port 314, which may include various communication ports (e.g., Universal Serial Bus (USB) Type-A and Type-C ports, High-Definition Multimedia Interface (HDMI) ports, Bluetooth, Ethernet, wireless Ethernet) may be coupled to one or more input/output and/or accessory devices. Such input/output and accessory devices can include a controller 350 such as a DualSense®, DualShock®, or Access™ controllers for PlayStation® devices, a virtual reality (VR) or augmented reality (AR) headset 352 such as the PS VR2 headset, accessory controllers 354 such as PS VR2 Sense™, a handheld gaming device 356 such as PlayStation Portal®, a camera 358, and/or an earphone/headphone set 360 such as the PULSE Elite™ headset or the Pulse Explore™ earbuds. In some implementations, the computing device 300 includes one or more acoustic transducers, and/or is connected to one or more external acoustic transducers such as one or more speakers associated with the display 316.

The processor 302 can be implemented as a chipset of chips that include separate and multiple analog and digital processors. For example, the processor 302 can be a multi-core processor that supports high-speed processing and enables complex computational tasks, real-time physics simulations, and advanced artificial intelligence (AI) capabilities. In one example, the processor 302 includes at least 8 cores, at least 16 threads, and operates at variable frequencies around 3.5 GHz or more. In some implementations, the processor 302 may be a Complex Instruction Set Computers (CISC) processor, a Reduced Instruction Set Computer (RISC) processor, or a Minimal Instruction Set Computer (MISC) processor.

In some implementations, the GPU 303 includes a custom GPU that supports an advanced architecture such as the RDNA 2 architecture developed by AMD. In certain examples, the GPU 303 includes at least 36 compute units running at speeds of 2 GHz or more, and delivers performance of at least 10 teraflops. The GPU 303 can be configured to support high quality graphics rendering. For example, the GPU 303 can be configured to support hardware-accelerated ray tracing for enhanced realism in lighting and reflections, thereby providing a highly immersive gaming experience.

The computing device 300 can be configured to interact with one or more connected input/output or accessory device in providing the gaming experience. In some implementations, the computing device communicates with a handheld controller 350—e.g., a DualSense®, DualShock®, or Access™ controller for PlayStation® devices—to provide the gaming experience. The controller 350 can feature a high-fidelity haptic feedback system with one or more actuators that simulate a wide range of tactile sensations. In some implementations, the controller 350 includes one or more adaptive triggers that adjust resistance based on in-game actions to provide for a realistic feel.

The ergonomic design of the controller 350 can allow for comfortable use even in long gaming sessions. For example, the controller 350 can include textured grips and an optimized button layout. In some implementations, the controller 350 includes one or more of: integrated motion sensors, a high-resolution touchpad, and a built-in microphone array. The controller 350 includes an array of buttons, joysticks, and other controls that allow a user to interact with the computing device 300 to participate in interactive gameplay presented, for example, on a display device such as the display 316. The controller 350 can be powered by one or more regular or rechargeable batteries and supports both wireless and wired connectivity with the computing device 300, for example, via Bluetooth, WiFi, USB-C etc., or via a proprietary connection such as PlayStation Link™. In some implementations, the controller 350 includes a light bar and player indicators for visual feedback and customization.

In some implementations, the input/output or accessory device includes a VR/AR headset 352. One example of such a headset is the PlayStation VR2 (PS VR2) headset that is configured to provide an immersive and interactive gaming experience. In some implementations, the headset 352 features dual displays, e.g., organic light emitting device displays or micro-LED displays, with a combined resolution of 4000 3 2080 pixels or higher—thus providing sharp visuals and a wide field of view.

In some implementations, the VR/AR headset 352 includes eye-tracking technology that enables foveated rendering, by focusing on where the user is looking. In some implementations, the headset 352 includes integrated cameras that facilitate tracking head movements without external sensors. In some implementations, the headset includes haptic feedback for tactile sensations and/or one or more acoustic transducers configured to provide a spatial sound effect the user. The headset 352 can include an adjustable headband and cushioned padding, and can be configured to connect to the computing device 300 either over a wireless network (e.g., over a WiFi® or Bluetooth® connection, or a proprietary connection such as PlayStation Link™) or over a wire such as a USB-C cable.

In some implementations, the headset 352 can be configured to work in conjunction with one or more accessory controllers 354 such as the PlayStation VR 2 —Sense™ controllers. The accessory controllers 354 can enhance the immersive gaming experience through various features such as advanced haptic feedback for detailed in-game sensations, adaptive triggers with dynamic resistance to simulate real-world actions, and finger touch detection for natural interactions. The ergonomics of the accessory controllers 354 can provide a comfortable experience even during extended gameplay. In some implementations, the accessory controllers include one or more integrated sensors (accelerometer, gyroscope, etc.) and/or cameras to provide motion tracking. The accessory controllers 354 can be configured to connect to the computing device 300 and/or the headset 352 over a wireless connection such as WiFi® or Bluetooth®.

In some implementations, the computing device 300 is connected to a handheld gaming device 356 such as the PlayStation Portal®. The handheld gaming device 356 can be configured to stream games and media from the computing device 300 via a wireless connection such as WiFi® or Bluetooth®. The handheld gaming device 356 includes a high-resolution screen that allows users to play games and/or stream media remotely without using the display 316 connected to the computing device 300. This allows the display to be used for other purposes while the computing device 300 facilitates gameplay on the handheld gaming device 356. In some implementations, the handheld gaming device 356 is configured to act as a streaming receiver without running games natively on the device 356 itself. This makes the handheld gaming device 356 a convenient option for playing games run on the computing device 300, while leaving a TV connected to the computing device 300 free to be used for viewing other media. The handheld gaming device 356 can includes buttons and features similar to (or even same as) the controller 350, thus providing for a similar gaming experience as that with the controller 350.

In some implementations, the input/output or accessory devices includes a camera 358 and/or an earphone/headphone set 360 such as the PULSE Elite™ headset or the Pulse Explore™ earbuds. The camera 358 can be used to track user-movements, which in turn can be used as an input to an interactive game being executed on the computing device 300. The earphone/headphone set 360 can be used to provide audio feedback/output to a user from the computing device 300. In some implementations, the earphone/headphone set 360 can include a microphone to receive spoken inputs/instructions that in turn can be used to control an interactive game being executed on the computing device 300.

While this specification contains many specific implementation details, these should not be construed as limitations on the scope of what is being claimed, which is defined by the claims themselves, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A system comprising:
one or more processors, and
one or more non-transitory computer-readable media that store instructions which, when executed by the one or more processors, cause the one or more processors to perform operations comprising:
accessing an image;
generating, using the image, two or more overlapping image segments;
detecting a plurality of objects depicted in the image;
generating, for at least some of the plurality of objects, one or more rules that define allowed interactions with the respective object, wherein generating the one or more rules comprises generating, using an image segment of the two or more overlapping image segments, a rule that defines a sequence of two or more allowed interactions each of which is for a respective object depicted in the image segment, and wherein at least one pair of objects from the respective objects for allowed interactions from the sequence of two or more allowed interactions are a distance apart that satisfies a threshold distance;
generating, using the image and the one or more rules for the at least some of the plurality of objects, an interactive image; and
providing an instruction to cause the device to display the interactive image that depicts the plurality of objects.

2. The system of claim 1, the operations comprising:
receiving a seed input that comprises one or more unrestricted phrases; and
in response to receiving the seed input, generating an image prompt, wherein:
accessing the image comprises generating the image using the image prompt; and
generating the one or more rules comprises generating the one or more rules that define a restricted set of allowed interactions with the respective object.

3. The system of claim 2, the operations comprising:
determining whether the one or more rules or the plurality of objects satisfy one or more validation criteria for the seed input; and
selectively updating or determining to skip updating at least one of the image or the plurality of objects using a result of the determination whether the one or more rules or the plurality of objects satisfy the one or more validation criteria for the seed input.

4. The system of claim 3, wherein selectively updating or determining to skip updating comprises updating at least one of the image or the plurality of objects using a result of the determination whether the one or more rules or the plurality of objects satisfy the one or more validation criteria for the seed input.

5. The system of claim 4, wherein the updating comprises adding, to a data object for an object depicted in the image, data indicating a second, different object is hidden inside the object until detection of an interaction with the object.

6-7. (canceled)

8. The system of claim 1, wherein:
detecting the plurality of objects depicted in the image uses a vision language model that receives, as input, data identifying candidate objects and the image and generates, as output and for each of the plurality of detected objects in the image, a label and location information.

9. The system of claim 8, wherein the location information comprises a bounding box.

10. The system of claim 1, the operations comprising:
detecting a first plurality of objects depicted in a first image;
determining whether there is an object in the first plurality of objects for each of the plurality of objects for which the one or more rules were generated; and
generating a second image in response to determining that there is not an object in the first plurality of objects for each of the plurality of objects for which the one or more rules were generated, wherein:
the image comprises the second image; and
detecting the plurality of objects comprises detecting the plurality of objects in the second image.

11. The system of claim 1, the operations comprising:
detecting a first plurality of objects depicted in a first image;
determining whether there is an object in the first plurality of objects for each of the plurality of objects for which the one or more rules were generated; and
generating, as the image and using the first image, a second image by modifying the first image in response to determining that there is not an object in the first plurality of objects for each of the plurality of objects for which the one or more rules were generated.

12. The system of claim 11, wherein modifying the first image to generate the second image comprises adding, to the first image, one or more objects from the plurality objects that were not included in the first plurality of objects detected in the first image.

13. The system of claim 1, the operations comprising:
detecting a first plurality of objects depicted in the image; and
determining whether there is an object in the first plurality of objects for each of the plurality of objects for which the one or more rules were generated, wherein:
detecting the plurality of objects depicted in the image is responsive to determining that there is not an object in the first plurality of objects for each of the plurality of objects for which the one or more rules were generated.

14. The system of claim 1, wherein generating the one or more rules that define the allowed interactions with the respective object uses a large language model that receives, as input, a template that defines a rule layout and generates, as output, the one or more rules.

15. The system of claim 14, wherein the large language model receives, as input, the template and data that identifies the plurality of objects.

16. ) One or more non-transitory computer-readable storage media that store instructions that, when executed by one or more processors, cause the one or more processors to perform operations comprising:
accessing an image;
generating, using the image, two or more overlapping image segments;
detecting a plurality of objects depicted in the image;
generating, for at least some of the plurality of objects, one or more rules that define allowed interactions with the respective object, wherein generating the one or more rules comprises generating, using an image segment of the two or more overlapping image segments, a rule that defines a sequence of two or more allowed interactions each of which is for a respective object depicted in the image segment, and wherein at least one pair of objects from the respective objects for allowed interactions from the sequence of two or more allowed interactions are a distance apart that satisfies a threshold distance;
generating, using the image and the one or more rules for the at least some of the plurality of objects, an interactive image; and
providing an instruction to cause the device to display the interactive image that depicts the plurality of objects.

17. The one or more computer storage media of claim 16, the operations comprising:
receiving a seed input that comprises one or more unrestricted phrases; and
in response to receiving the seed input, generating an image prompt, wherein:
accessing the image comprises generating the image using the image prompt; and
generating the one or more rules comprises generating the one or more rules that define a restricted set of allowed interactions with the respective object.

18. The one or more computer storage media of claim 17, the operations comprising:
determining whether the one or more rules or the plurality of objects satisfy one or more validation criteria for the seed input; and
selectively updating or determining to skip updating at least one of the image or the plurality of objects using a result of the determination whether the one or more rules or the plurality of objects satisfy the one or more validation criteria for the seed input.

19. (canceled)

20. A computer-implemented method comprising:
accessing an image;
generating, using the image, two or more overlapping image segments;
detecting a plurality of objects depicted in the image;
generating, for at least some of the plurality of objects, one or more rules that define allowed interactions with the respective object, wherein generating the one or more rules comprises generating, using an image segment of the two or more overlapping image segments, a rule that defines a sequence of two or more allowed interactions each of which is for a respective object depicted in the image segment, and wherein at least one pair of objects from the respective objects for allowed interactions from the sequence of two or more allowed interactions are a distance apart that satisfies a threshold distance;
generating, using the image and the one or more rules for the at least some of the plurality of objects, an interactive image; and
providing an instruction to cause the device to display the interactive image that depicts the plurality of objects.

21. The method of claim 20, comprising:
receiving a seed input that comprises one or more unrestricted phrases; and
in response to receiving the seed input, generating an image prompt, wherein:
accessing the image comprises generating the image using the image prompt; and
generating the one or more rules comprises generating the one or more rules that define a restricted set of allowed interactions with the respective object.

22. The method of claim 21, comprising:
determining whether the one or more rules or the plurality of objects satisfy one or more validation criteria for the seed input; and
selectively updating or determining to skip updating at least one of the image or the plurality of objects using a result of the determination whether the one or more rules or the plurality of objects satisfy the one or more validation criteria for the seed input.

23. The method of claim 22, wherein selectively updating or determining to skip updating comprises updating at least one of the image or the plurality of objects using a result of the determination whether the one or more rules or the plurality of objects satisfy the one or more validation criteria for the seed input.
